(19) United States
(12) Patent Application Publication
(10) Pub. No.: US 2012/0081595 A1
(43) Pub. Date: Apr. 5, 2012

(54) IMAGE TAKING OPTICAL SYSTEM AND IMAGE PICKUP APPARATUS EQUIPPED WITH SAME

(75) Inventor: Yoshihiro UCHIDA, Tokyo (JP)

(73) Assignee: OLYMPUS CORPORATION, Tokyo (JP)

(21) Appl. No.: 13/234,500

(22) Filed: Sep. 16, 2011

(30) Foreign Application Priority Data
Oct. 4, 2010 (JP) 2010-224760

(51) Int. Cl. H04N 5/225; G02B 9/60

(52) U.S. Cl. 348/340; 359/764; 348/E05.045

(57) ABSTRACT

An optical system comprises, in order from the object side, a first lens having a biconvex shape and having a positive refractive power, a second lens having a meniscus shape with a concave surface facing the object side and having a negative refractive power, a third lens having a negative refractive power, a fourth lens having a meniscus shape with a concave surface facing the object side and having a positive refractive power, and a fifth lens having a negative refractive power. The first lens and the second lens are cemented together.

### CROSS-REFERENCE TO RELATED APPLICATION

The present application is based upon and claims the benefit of priority from the prior Japanese Patent Application No. 2010-224760 filed on Oct. 4, 2010; the entire contents of which are incorporated herein by reference.

### BACKGROUND OF THE INVENTION

1. Field of the Invention

The present invention relates to an image taking optical system and an image pickup apparatus equipped with same.

2. Description of the Related Art

With slimming of cellular phones, portable digital assistances, and notebook computers in these years, camera modules with an optical system having an extremely short length along the optical axis are demanded. To meet this demand, many optical systems having a short focal length composed of two or three aspheric lenses have been developed.

In recent years, on the other hand, with technical progress in the field of image pickup elements and an increasing need in the market, small, low-price camera modules having a large number of pixels and a wide angle of view are demanded. As optical systems that are designed to have a reduced overall length while having improved imaging performance, optical systems composed of four or five lenses are disclosed in Japanese Patent No. 4317933 and Japanese Patent Application Laid-Open No. 2007-264180.

### SUMMARY OF THE INVENTION

An image taking optical system comprising, in order from the object side:

a first lens having a biconvex shape and having a positive refractive power;

a second lens having a meniscus shape with a concave surface facing the object side and having a negative refractive power;

a third lens having a negative refractive power;

a fourth lens having a meniscus shape with a concave surface facing the object side and having a positive refractive power; and

a fifth lens having a negative refractive power,

wherein the first lens and the second lens are cemented together.

An image pickup apparatus according to the present invention comprises the above-described image taking optical system and an image pickup element having an image pickup surface.

### BRIEF DESCRIPTION OF THE DRAWINGS

FIG. 1 is cross sectional view taken along the optical axis, showing the optical configuration of an image taking optical system according to a first embodiment of the present invention in the state in which the optical system is focused on an object point at infinity;

FIGS. 2A, 2B, 2C and 2D show spherical aberration (SA), astigmatism (AS), distortion (DT), and chromatic aberration of magnification (CC) of the image taking optical system according to the first embodiment in the state in which the optical system is focused on an object point at infinity;

FIG. 3 is cross sectional view taken along the optical axis, showing the optical configuration of an image taking optical system according to a second embodiment of the present invention in the state in which the optical system is focused on an object point at infinity;

FIGS. 4A, 4B, 4 C and 4D show spherical aberration (SA), astigmatism (AS), distortion (DT), and chromatic aberration of magnification (CC) of the image taking optical system according to the second embodiment in the state in which the optical system is focused on an object point at infinity;

FIG. 5 is cross sectional view taken along the optical axis, showing the optical configuration of an image taking optical system according to a third embodiment of the present invention in the state in which the optical system is focused on an object point at infinity;

FIGS. 6A, 6B, 6 C and 6D show spherical aberration (SA), astigmatism (AS), distortion (DT), and chromatic aberration of magnification (CC) of the image taking optical system according to the third embodiment in the state in which the optical system is focused on an object point at infinity;

FIG. 7 is cross sectional view taken along the optical axis, showing the optical configuration of an image taking optical system according to a fourth embodiment of the present invention in the state in which the optical system is focused on an object point at infinity;

FIGS. 8A, 8B, 8 C and 8D show spherical aberration (SA), astigmatism (AS), distortion (DT), and chromatic aberration of magnification (CC) of the image taking optical system according to the fourth embodiment in the state in which the optical system is focused on an object point at infinity;

FIG. 9 is cross sectional view taken along the optical axis, showing the optical configuration of an image taking optical system according to a fifth embodiment of the present invention in the state in which the optical system is focused on an object point at infinity;

FIGS. 10A, 10B, 10C and 10D show shows spherical aberration (SA), astigmatism (AS), distortion (DT), and chromatic aberration of magnification (CC) of the image taking optical system according to the fifth embodiment in the state in which the optical system is focused on an object point at infinity;

FIG. 11 is a front perspective view showing an outer appearance of a digital camera 40 equipped with an image taking optical system according to the present invention;

FIG. 12 is a rear perspective view of the digital camera 40;

FIG. 13 is a cross sectional view showing the optical construction of the digital camera 40;

FIG. 14 is a front perspective view showing a personal computer 300 as an example of an information processing apparatus, in which an image taking optical system according to the present invention is provided as an objective optical system, in a state in which the cover is open;

FIG. 15 is a cross sectional view of the taking optical system 303 of the personal computer 300;

FIG. 16 is a side view of the personal computer 300; and

FIGS. 17A, 17B, and 17C show a cellular phone 400 as an example of an information processing apparatus in which an image taking optical system according to the present invention is provided as a photographic optical system, where FIG. 17A is a front view of the cellular phone 400, FIG. 17B is a side view of the cellular phone 400, and FIG. 17C is across sectional view of the taking optical system 405.

### DETAILED DESCRIPTION OF THE INVENTION

Prior to the description of the examples, the operation and effects of the image taking optical system according to an embodiment will be described.

An image taking optical system according to the embodiment includes, in order from the object side, a first lens having a biconvex shape and having a positive refractive power, a second lens having a meniscus shape with a concave surface facing the object side and having a negative refractive power, a third lens having a negative refractive power, a fourth lens having a meniscus shape with a concave surface facing the object side and having a positive refractive power, and a fifth lens having a negative refractive power, wherein the first lens and the second lens are cemented together.

If the principal point is located on the object side of the image taking optical system, the overall length of the optical system can be made satisfactorily short relative to the focal length. Then, a reduction in the overall length can be achieved.

The image side surface of the second lens is concave when seen from the object side. This allows to make the radius of curvature of the object side surface of the first lens large. In consequence, spherical aberration and coma can be made small.

It is preferred that the image taking optical system according to the embodiment satisfies the following conditional expression (1):

−1.6<(r2+r4)/(r2−r4)<−0.2 (1),

where r2 is the paraxial radius of curvature of the object side surface of the first lens, and r4 is the paraxial radius of curvature of the image side surface of the second lens.

If conditional expression (1) is satisfied, the overall length of the optical system can be made short, and it will be possible to correct aberrations satisfactorily.

If the upper limit of conditional expression (1) is exceeded, the paraxial radius of curvature of the object side surface of the first lens will be unduly small. Therefore, it will be difficult to correct spherical aberration.

If the lower limit of conditional expression (1) is not reached, the negative refractive power of the second lens will be low. Then, it will be difficult to correct axial chromatic aberration.

It is more preferred that the following conditional expression (1′) be satisfied instead of conditional expression (1):

−1.1<(r2+r4)/(r2−r4)<−0.4 (1′).

It is still more preferred that the following conditional expression (1″) be satisfied instead of conditional expression (1):

−1.0<(r2+r4)/(r2−r4)<−0.5 (1″).

It is preferred that the image taking optical system according to the embodiment satisfies the following conditional expression (2):

0.3<f12/f<1.9 (2),

where f12 is the composite focal length of the first lens and the second lens, and f is the focal length of the entire image taking optical system.

If conditional expression (2) is satisfied, the overall length of the optical system can be made short, and it will be possible to correct aberrations satisfactorily.

If the upper limit of conditional expression (2) is exceeded, the refractive power of the cemented lens will be unduly low. Then, it will be difficult to locate the principal point on the object side of the optical system. In consequence, it will be difficult to make the overall length short.

If the lower limit of conditional expression (2) is not reached, the refractive power of the cemented lens will be unduly high. Then, aberrations will be made worse, in particular spherical aberration will be made worse due to high marginal ray heights. In addition, correction of aberrations will be difficult due to increase in coma. Moreover, since the first lens will have the most part of the refractive power of the entire optical system, the first lens will have high sensitivity to manufacturing errors. For these reasons, it is not desirable that the lower limit of conditional expression (2) is not reached.

It is more preferred that the following conditional expression (2′) be satisfied instead of conditional expression (2):

0.5<f12/f<1.3 (2′).

It is still more preferred that the following conditional expression (2″) be satisfied instead of conditional expression (2):

0.6<f12/f<1.2 (2″).

It is preferred that the image taking optical system according to the embodiment satisfies the following conditional expression (3):

0.2<d6/f<1.2 (3),

where f is the focal length of the entire image taking optical system, and d6 is the air distance between the third lens and the fourth lens along the optical axis.

If conditional expression (3) is satisfied, the overall length of the optical system can be made short, and it will be possible to correct aberrations satisfactorily.

If the lower limit of conditional expression (3) is not reached, the difference between the ray height of off-axis beams in the third lens and that in the fourth lens will be small. As the fourth lens is intended to provide correction of high order curvature of field and distortion in particular, the effect of correction of aberrations by the fourth lens will be small. In consequence, it will be difficult to correct aberrations.

If the upper limit of conditional expression (3) is exceeded, while the extension of off-axis beams incident on the fourth lens can be ensured, the overall length will be large.

It is more preferred that the following conditional expression (3′) be satisfied instead of conditional expression (3):

0.3<d6/f<0.9 (3′).

It is still more preferred that the following conditional expression (3″) be satisfied instead of conditional expression (3):

0.4<d6/f<0.8 (3″).

It is preferred that the image taking optical system according to the embodiment satisfies the following conditional expression (4):

0.5<f12/f4<3.6 (4),

where f12 is the composite focal length of the first lens and the second lens, and f4 is the focal length of the fourth lens.

If conditional expression (4) is satisfied, the overall length of the optical system can be made short, and it will be possible to correct aberrations satisfactorily.

If the upper limit of conditional expression (4) is exceeded, the refractive power of the cemented lens will be high. Then, aberrations will be made worse, in particular, spherical aberration will be made worse due to high marginal ray heights. Moreover, it will be difficult to achieve aberration correction due to large coma. In addition, since the cemented lens will have the most part of the refractive power of the entire optical system, the cemented lens will have high sensitivity to manufacturing errors. For these reasons, it is not desirable that the upper limit is exceeded.

If the lower limit of conditional expression (4) is not reached, the refractive power of the fourth lens will be become high relative to that of the cemented lens. Then, it will be difficult to locate the principal point on the object side of the optical system. In consequence, it will be difficult to make the overall length of the optical system short.

It is more preferred that the following conditional expression (4′) be satisfied instead of conditional expression (4):

0.8<f12/f4<2.6 (4′).

It is still more preferred that the following conditional expression (4″) be satisfied instead of conditional expression (4):

0.9<f12/f4<2.3 (4″).

In the image taking optical system according to the embodiment, it is preferred that the fourth lens have a positive refractive power in its central portion and have a negative refractive power in its peripheral portion.

If this is the case, it is possible to correct curvature of field satisfactorily when the overall length is made short.

It is preferred that the image taking optical system according to the embodiment satisfies the following conditional expression (5):

0.21<|f5/f|<1.25 (5),

where f5 is the focal length of the fifth lens, and f is the focal length of the entire image taking optical system.

If conditional expression (5) is satisfied, it is possible to provide a sufficiently long back focus.

If the upper limit of conditional expression (5) is exceeded, the negative refractive power of the fifth lens will be low. Then, it will be difficult to locate the principal point on the object side of the optical system. In consequence, it will be difficult to make the overall length short.

If the lower limit of conditional expression (5) is not reached, the negative refractive power of the fifth lens will be high. Then, it will be difficult to provide a satisfactorily long back focus when the angle of view of the optical system is large.

It is more preferred that the following conditional expression (5′) be satisfied instead of conditional expression (5):

0.3<|f5/f|<0.87 (5′).

It is still more preferred that the following conditional expression (5″) be satisfied instead of conditional expression (5):

0.34<|f5/f|<0.76 (5″).

It is preferred that the image taking optical system according to the embodiment satisfies the following conditional expression (6):

0.1<d23/TL<0.5 (6),

where d23 is the thickness of the cemented lens, and TL is the distance from the vertex of the object side surface of the first lens to the vertex of the image side surface of the fifth lens, the distance referring not to the equivalent air distance but the actual distance.

If conditional expression (6) is satisfied, the overall length of the optical system can be made short, and it will be possible to correct aberrations satisfactorily.

If the upper limit of conditional expression (6) is exceeded, the position of the second lens will be made closer to the image side. Then, it is necessary to make the refractive power of the second lens higher. In consequence, it will be difficult to make coma small.

If the lower limit of conditional expression (6) is not reached, the positive refractive power of the cemented lens will be low. Then, it will be difficult to make the overall length short.

It is more preferred that the following conditional expression (6′) be satisfied instead of conditional expression (5):

0.2<d23/TL<0.4 (6′).

It is still more preferred that the following conditional expression (5″) be satisfied instead of conditional expression (5):

0.2<d23/TL<0.3 (6″).

In the image taking optical system according to the embodiment, it is preferred that the negative refractive power of the second lens increase from the center toward the periphery thereof.

This enables satisfactory correction of spherical aberration and coma.

In the image taking optical system according to the embodiment, it is preferred that the first lens, the second lens, the third lens, the fourth lens, and the fifth lens be each made of a resin.

With the use of a resin, the image taking lens can be provided at low price.

An image pickup apparatus according to an the embodiment of the invention includes the image taking optical system described above and an electronic image pickup element having an image pickup surface.

Thus, there can be provided a relatively small, high performance image taking optical system with well-corrected aberrations such as spherical aberration, astigmatism, curvature of field, chromatic aberration of magnification, and coma and an image pickup apparatus equipped with such an image taking optical system.

It is preferred that the image pickup apparatus according to the embodiment have an auto-focus mechanism integrated with the image taking optical system.

The auto-focus mechanism enables focusing on an object at any distance.

In the image pickup apparatus according to the embodiment, it is preferred that the image taking optical system and the electronic image pickup element be made integral.

The integration of the image pickup element enables conversion of an optical image formed by the image taking optical system into an electrical signal.

In the following, examples of the image taking optical system and the electronic image pickup apparatus according to the embodiment will be described in detail with reference to the drawings. It should be understood that the present invention is not limited by the examples.

In the following description, the positive/negative refractive power refers to one determined based on the paraxial radius of curvature.

The stop is located closest to the object side among the optical components in the optical system. Specifically, the stop is provided at a position closer to the object side than the image side surface of the first lens. More specifically, the stop is located between the object side surface and the image side surface of the first lens L1. The description “the stop is located closest to the object side among the optical components of the image taking optical system” shall be read to allow this location of the stop.

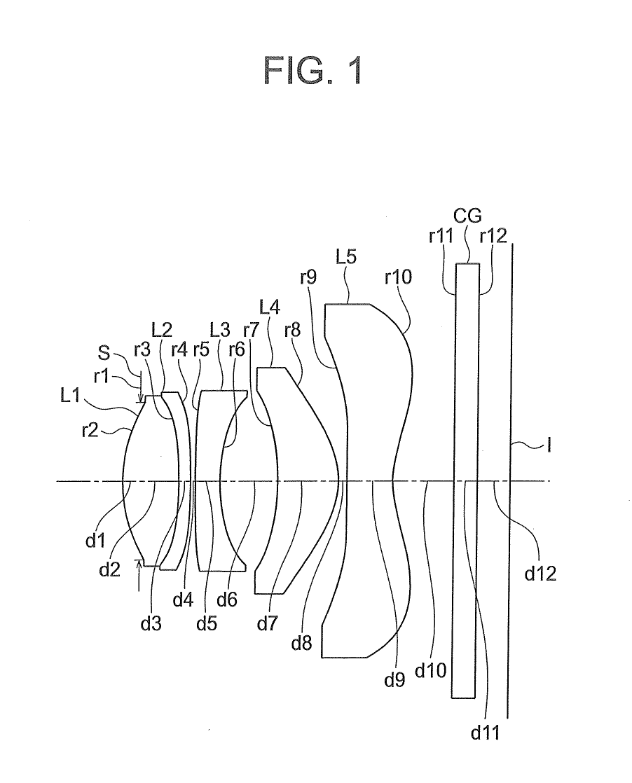

An image taking optical system according to a first example will be described. FIG. 1 is a cross sectional view taken along the optical axis, showing the optical configuration of the image taking optical system according to the first example in the state in which the image taking optical system is focused on a object point at infinity.

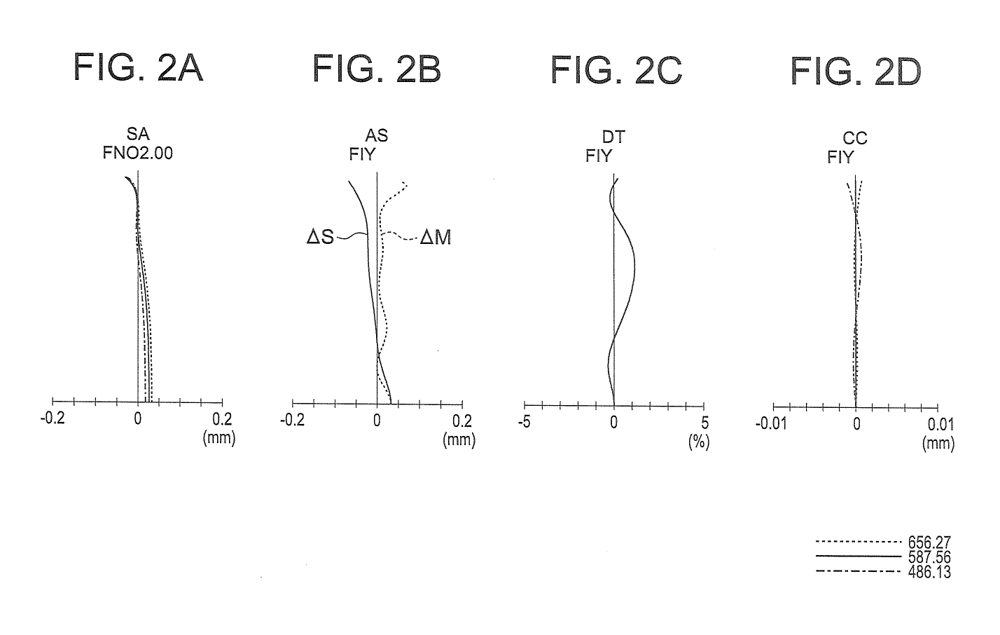

FIGS. 2A, 2B, 2C and 2D show spherical aberration (SA), astigmatism (AS), distortion (DT), and chromatic aberration of magnification (CC) of the image taking optical system according to the first example in the state in which the image taking optical system is focused on an object point at infinity. In FIGS. 2A, 2B, 2C and 2D, FIY is the image height. The same symbols will be used in the aberration diagrams of the other examples described in the following.

As shown in FIG. 1, the image taking optical system according to the first example includes, in order from the object side, an aperture stop S, a first lens L1 having a positive refractive power, a second lens L2 having a negative refractive power, a third lens L3 having a negative refractive power, a fourth lens L4 having a positive refractive power, and a fifth lens L5 having a negative refractive power. In the cross sectional view of the image taking optical systems according to this and all the other examples described in the following, CG denotes a cover glass, and I denotes an image pickup surface of the electronic image pickup element.

The first lens L1 and the second lens L2 are cemented together.

The first lens L1 is a biconvex positive lens. The second lens L2 is a negative meniscus lens having a concave surface facing the object side. The third lens L3 is a biconcave negative lens. The fourth lens L4 is a negative meniscus lens having a concave surface facing the object side. The fifth lens L5 is a negative meniscus lens having a convex surface facing the object side.

Both surfaces of all of the first to fifth lenses L1 to L5 are aspheric surfaces.

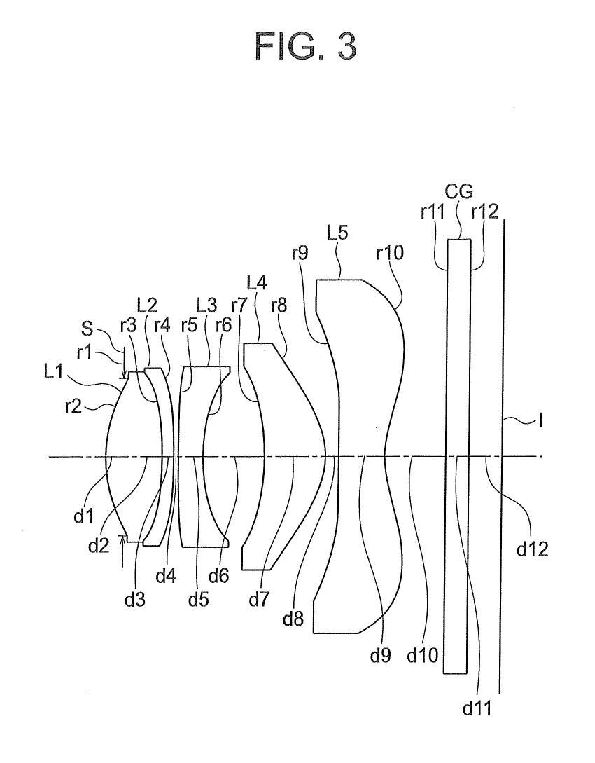

Next, an image taking optical system according to a second example will be described. FIG. 3 is a cross sectional view taken along the optical axis, showing the optical configuration of the image taking optical system according to the second examples in the state in which the image taking optical system is focused on a object point at infinity.

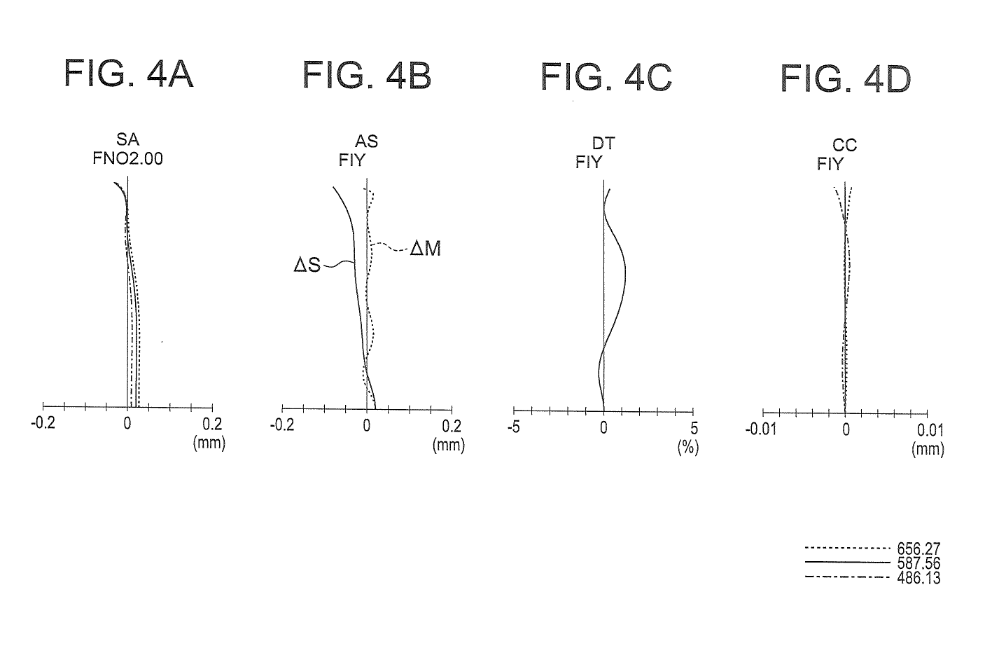

FIGS. 4A, 4B, 4 C and 4D show spherical aberration (SA), astigmatism (AS), distortion (DT), and chromatic aberration of magnification (CC) of the image taking optical system according to the second example in the state in which the image taking optical system is focused on an object point at infinity.

As shown in FIG. 3, the image taking optical system according to the second example includes, in order from the object side, an aperture stop S, a first lens L1 having a positive refractive power, a second lens L2 having a negative refractive power, a third lens L3 having a negative refractive power, a fourth lens L4 having a positive refractive power, and a fifth lens L5 having a negative refractive power.

The first lens L1 and the second lens L2 are cemented together.

The first lens L1 is a biconvex positive lens. The second lens L2 is a negative meniscus lens having a concave surface facing the object side. The third lens L3 is a biconcave negative lens. The fourth lens L4 is a negative meniscus lens having a concave surface facing the object side. The fifth lens L5 is a negative meniscus lens having a convex surface facing the object side.

Both surfaces of all of the first to fifth lenses L1 to L5 are aspheric surfaces.

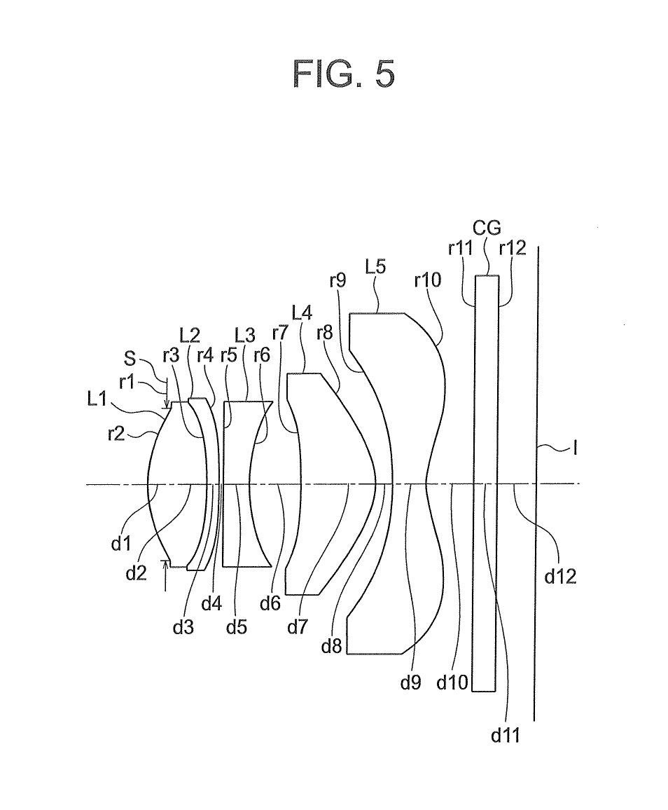

Next, an image taking optical system according to a third example will be described. FIG. 5 is a cross sectional view taken along the optical axis, showing the optical configuration of the image taking optical system according to the third example in the state in which the image taking optical system is focused on a object point at infinity.

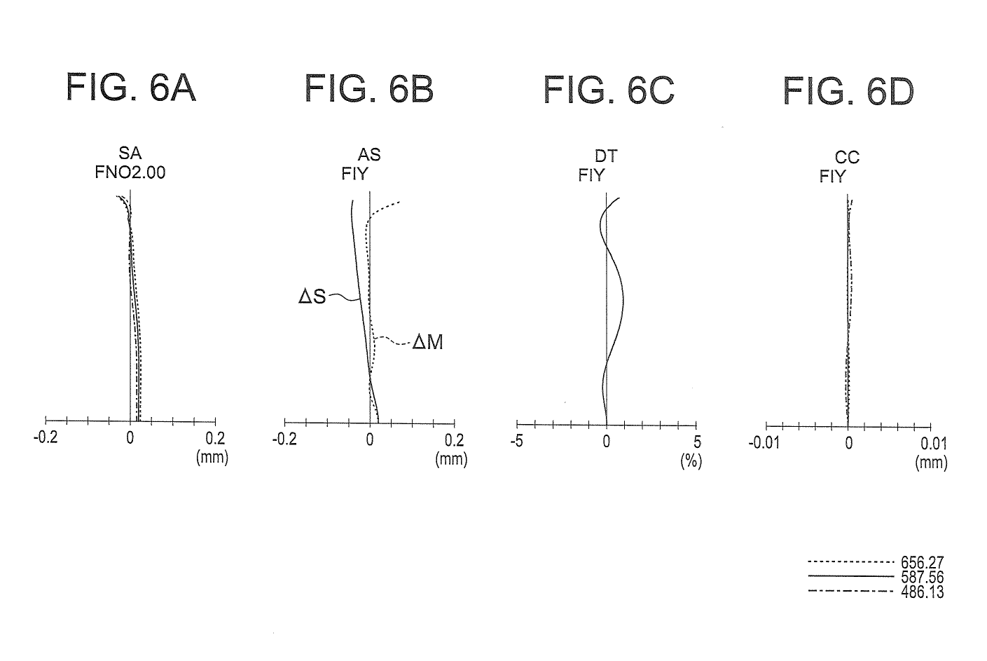

FIGS. 6A, 6B, 6 C and 6D show spherical aberration (SA), astigmatism (AS), distortion (DT), and chromatic aberration of magnification (CC) of the image taking optical system according to the third example in the state in which the image taking optical system is focused on an object point at infinity.

As shown in FIG. 5, the image taking optical system according to the third example includes, in order from the object side, an aperture stop S, a first lens L1 having a positive refractive power, a second lens L2 having a negative refractive power, a third lens L3 having a negative refractive power, a fourth lens L4 having a positive refractive power, and a fifth lens L5 having a negative refractive power.

The first lens L1 and the second lens L2 are cemented together.

The first lens L1 is a biconvex positive lens. The second lens L2 is a negative meniscus lens having a concave surface facing the object side. The third lens L3 is a biconcave negative lens. The fourth lens L4 is a negative meniscus lens having a concave surface facing the object side. The fifth lens L5 is a biconcave negative lens.

Both surfaces of all of the first to fifth lenses L1 to L5 are aspheric surfaces.

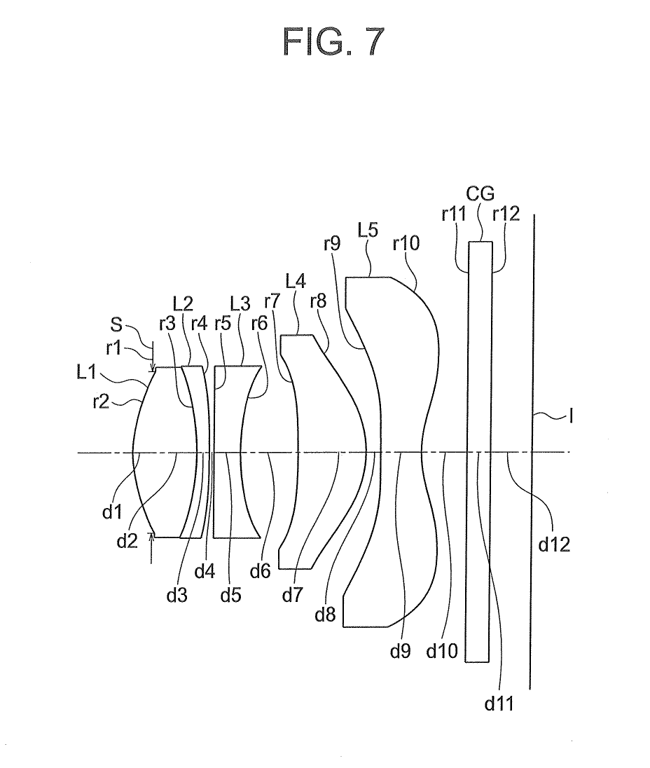

Next, an image taking optical system according to a fourth example will be described. FIG. 7 is a cross sectional view taken along the optical axis, showing the optical configuration of the image taking optical system according to the fourth example in the state in which the image taking optical system is focused on a object point at infinity.

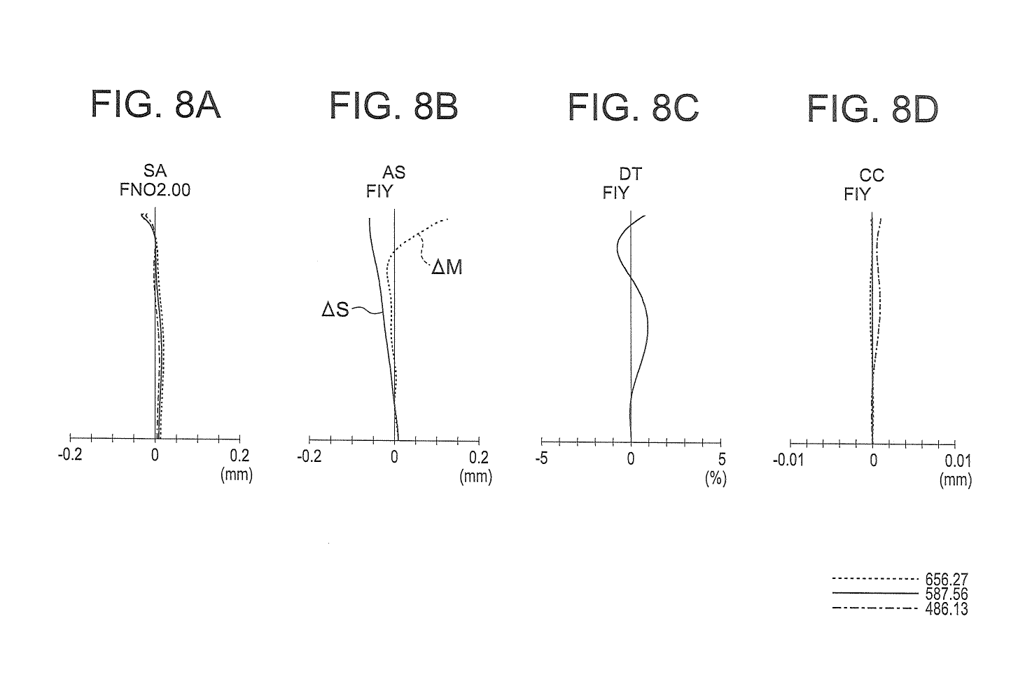

FIGS. 8A, 8B, 8 C and 8D show spherical aberration (SA), astigmatism (AS), distortion (DT), and chromatic aberration of magnification (CC) of the image taking optical system according to the fourth example in the state in which the image taking optical system is focused on an object point at infinity.

As shown in FIG. 7, the image taking optical system according to the fourth example includes, in order from the object side, an aperture stop S, a first lens L1 having a positive refractive power, a second lens L2 having a negative refractive power, a third lens L3 having a negative refractive power, a fourth lens L4 having a positive refractive power, and a fifth lens L5 having a negative refractive power.

The first lens L1 and the second lens L2 are cemented together.

The first lens L1 is a biconvex positive lens. The second lens L2 is a negative meniscus lens having a concave surface facing the object side. The third lens L3 is a biconcave negative lens. The fourth lens L4 is a negative meniscus lens having a concave surface facing the object side. The fifth lens L5 is a biconcave negative lens.

Both surfaces of all of the first to fifth lenses L1 to L5 are aspheric surfaces.

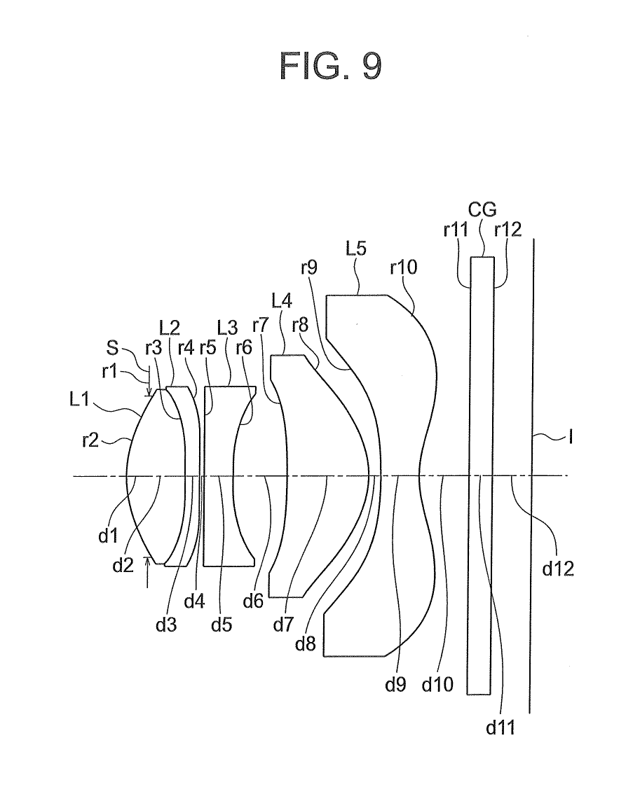

Next, an image taking optical system according to a fifth example will be described. FIG. 9 is a cross sectional view taken along the optical axis, showing the optical configuration of the image taking optical system according to the fifth example in the state in which the image taking optical system is focused on a object point at infinity.

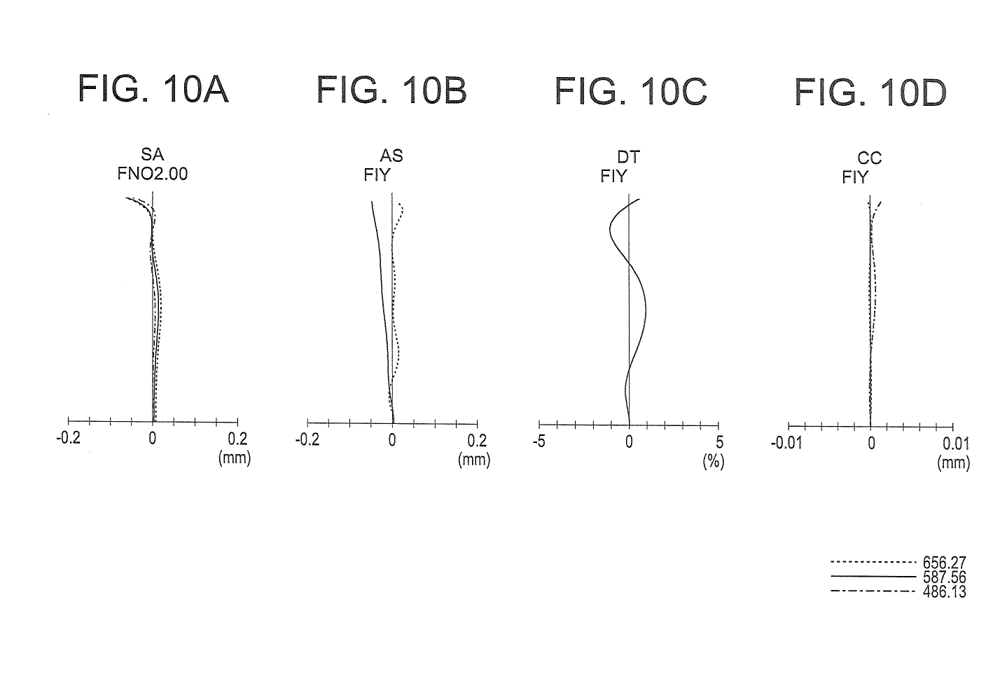

FIGS. 10A, 10B, 10C and 10D show spherical aberration (SA), astigmatism (AS), distortion (DT), and chromatic aberration of magnification (CC) of the image taking optical system according to the fifth example in the state in which the image taking optical system is focused on an object point at infinity.

As shown in FIG. 9, the image taking optical system according to the fifth example includes, in order from the object side, an aperture stop S, a first lens L1 having a positive refractive power, a second lens L2 having a negative refractive power, a third lens L3 having a negative refractive power, a fourth lens L4 having a positive refractive power, and a fifth lens L5 having a negative refractive power.

The first lens L1 and the second lens L2 are cemented together.

The first lens L1 is a biconvex positive lens. The second lens L2 is a negative meniscus lens having a concave surface facing the object side. The third lens L3 is a biconcave negative lens. The fourth lens L4 is a negative meniscus lens having a concave surface facing the object side. The fifth lens L5 is a biconcave negative lens.

Both surfaces of all of the first to fifth lenses L1 to L5 are aspheric surfaces.

Numerical data of each example described above is shown below. Each of r1, r2, . . . denotes radius of curvature of each lens surface, each of d1, d2, . . . denotes a distance between two lenses, each of nd1, nd2, . . . denotes a refractive index of each lens for a d-line, and each of vd1, vd2, . . . denotes an Abbe constant for each lens. FNO denotes an F number, f denotes a focal length of the entire zoom lens system, FIY denotes an image height. WE denotes a wide angle end, ST denotes an intermediate state, TE denotes a telephoto end, Further, * denotes an aspheric data.

BF (back focus) is a unit which is not expressed upon air conversion of a distance from the last lens surface up to a paraxial image plane.

When x is let to be an optical axis with a direction of traveling of light as a positive (direction), and y is let to be in a direction orthogonal to the optical axis, a shape of the aspheric surface is described by the following expression.

z=(y²/r)/[1+{1−(K+1)(y/r)²}^{1/2}]+A₄y⁴+A₆y⁶+A₈y⁸+A₁₀y¹⁰+A₁₂y¹²

where r denotes a paraxial radius of curvature, K denotes a conical coefficient, A4, A6, A8, A10, and A₁₂ denote aspherical surface coefficients of a fourth order, a sixth order, an eight order, a tenth order, and a twelfth order respectively. Moreover, in the aspherical surface coefficients, ‘e-n’ (where, n is an integral number) indicates ‘10⁻ⁿ’.

These symbols are common in the following numerical examples.

### Example 1

Unit mm
Surface data

| Surface no. | r | d | nd | νd |
|---|---|---|---|---|
| Object plane | ∞ | ∞ | | |
| 1(Stop) | ∞ | −0.23 | | |
| 2* | 1.859 | 0.74 | 1.52778 | 51.90 |
| 3* | −3.628 | 0.15 | 1.61139 | 27.10 |
| 4* | −6.630 | 0.05 | | |
| 5* | 10.338 | 0.33 | 1.61420 | 25.60 |
| 6* | 2.372 | 0.76 | | |
| 7* | −3.097 | 0.80 | 1.53367 | 55.87 |
| 8* | −1.035 | 0.11 | | |
| 9* | 26.060 | 0.60 | 1.53367 | 55.87 |
| 10* | 1.255 | 0.80 | | |
| 11 | ∞ | 0.30 | 1.51633 | 64.14 |
| 12 | ∞ | 0.43 | | |
| Image plane | ∞ | | | |
| (Light receiving surface) | | | | |

Aspherical surface data

2nd surface
K = −0.736
A4 = 8.88778e−04, A6 = −1.13803e−03, A8 = −5.43438e−04,
A10 = −8.57673e−03
3rd surface
K = −2.191
A4 = 5.42755e−03, A6 = −3.81447e−02, A8 = −1.10124e−04,
A10 = −2.62717e−03
4th surface
K = 2.000
A4 = −1.67744e−02, A6 = −1.27719e−02, A8 = −4.24376e−03,
A10 = 3.48195e−04
5th surface
K = −3.700
A4 = −2.12111e−02, A6 = −8.66594e−03, A8 = 9.78694e−03,
A10 = 6.94903e−03, A12 = −6.03743e−04
6th surface
K = 0.576
A4 = 8.14677e−03, A6 = −2.97061e−03, A8 = 1.26283e−02,
A10 = −3.04884e−03, A12 = 7.01275e−03
7th surface
K = 4.240
A4 = 1.63585e−02, A6 = −1.69256e−03, A8 = 2.89133e−03,
A10 = 4.74761e−03, A12 = −3.33582e−03
8th surface
K = −2.897
A4 = −6.73134e−03, A6 = −3.42128e−02, A8 = 2.35999e−02,
A10 = −3.64117e−03, A12 = −5.86432e−05
9th surface
K = 0.000
A4 = −5.22548e−02, A6 = 4.92339e−03, A8 = 8.10014e−04,
A10 = −1.52456e−04, A12 = 1.48376e−05
10th surface
K = −7.765
A4 = −4.92544e−02, A6 = 1.05810e−02, A8 = −2.46845e−03,
A10 = 2.53925e−04, A12 = −1.19965e−05

| | |
|---|---|
| Fno. | 2.0 |
| BF(in air) | 1.43 |
| Lens total length(in air) | 4.97 |
| Focal length | 4.20 |
| Image height | 2.9 |

### Example 2

Unit mm
Surface data

| Surface no. | r | d | nd | νd |
|---|---|---|---|---|
| Object plane | ∞ | ∞ | | |
| 1(Stop) | ∞ | −0.22 | | |
| 2* | 1.860 | 0.74 | 1.52778 | 51.90 |
| 3* | −3.788 | 0.15 | 1.61139 | 27.10 |
| 4* | −6.607 | 0.05 | | |
| 5* | 10.396 | 0.33 | 1.61420 | 25.60 |
| 6* | 2.390 | 0.75 | | |
| 7* | −3.012 | 0.82 | 1.53367 | 55.87 |
| 8* | −1.026 | 0.15 | | |
| 9* | 24.161 | 0.55 | 1.53367 | 55.87 |
| 10* | 1.242 | 0.80 | | |
| 11 | ∞ | 0.30 | 1.51633 | 64.14 |
| 12 | ∞ | 0.43 | | |
| Image plane | ∞ | | | |
| (Light receiving surface) | | | | |

Aspherical surface data

2nd surface
K = −0.747
A4 = 2.46036e−04, A6 = −4.43494e−04, A8 = −7.72758e−04,
A10 = −8.75568e−03
3rd surface
K = −1.016
A4 = 2.82720e−03, A6 = −3.94524e−02, A8 = −3.17586e−04,
A10 = −1.26278e−03
4th surface
K = 7.360
A4 = −1.58496e−02, A6 = −1.25654e−02, A8 = −4.24178e−03,
A10 = 2.37922e−04
5th surface
K = −2.972
A4 = −2.10322e−02, A6 = −7.69958e−03, A8 = 8.93221e−03,
A10 = 5.27543e−03, A12 = −8.76659e−05
6th surface
K = 0.696
A4 = 1.04051e−02, A6 = −6.56787e−03, A8 = 1.41892e−02,
A10 = 2.49723e−04, A12 = 2.54944e−03
7th surface
K = 4.534
A4 = 1.95825e−02, A6 = 2.56387e−03, A8 = 2.53300e−03,
A10 = 5.05379e−03, A12 = −1.85110e−03
8th surface
K = −2.918
A4 = −6.07297e−03, A6 = −3.50335e−02, A8 = 2.38443e−02,
A10 = −3.52876e−03, A12 = 2.15394e−05
9th surface
K = 0.000
A4 = −5.23441e−02, A6 = 3.78238e−03, A8 = 6.66390e−04,
A10 = −4.48013e−05, A12 = 1.05328e−05
10th surface
K = −7.693
A4 = −5.15434e−02, A6 = 1.08152e−02, A8 = −2.44349e−03,
A10 = 1.98074e−04, A12 = 1.38627e−06, A14 = −1.00000e−06

| | |
|---|---|
| Fno. | 2.0 |
| BF(in air) | 1.43 |
| Lens total length(in air) | 4.97 |
| Focal length | 4.19 |
| Image height | 2.9 |

### Example 3

Unit mm
Surface data

| Surface no. | r | d | nd | νd |
|---|---|---|---|---|
| Object plane | ∞ | ∞ | | |
| 1(Stop) | ∞ | −0.25 | | |
| 2* | 1.835 | 0.75 | 1.52400 | 50.40 |
| 3* | −2.781 | 0.18 | 1.61700 | 27.20 |
| 4* | −7.948 | 0.05 | | |
| 5* | 8.685 | 0.35 | 1.61420 | 25.60 |
| 6* | 2.435 | 0.68 | | |
| 7* | −5.015 | 0.99 | 1.53367 | 55.87 |
| 8* | −1.048 | 0.19 | | |
| 9* | −15.490 | 0.50 | 1.53367 | 55.87 |
| 10* | 1.223 | 0.60 | | |
| 11 | ∞ | 0.30 | 1.51633 | 64.14 |
| 12 | ∞ | 0.52 | | |
| Image plane | ∞ | | | |
| (Light receiving surface) | | | | |

Aspherical surface data

2nd surface
K = −0.074
A4 = −7.65886e−03, A6 = 7.64758e−03, A8 = −1.27304e−02,
A10 = 1.12325e−03
3rd surface
K = −2.300
A4 = 7.43092e−02, A6 = −4.25252e−02, A8 = −5.46544e−02,
A10 = 7.21899e−03
4th surface
K = 0.769
A4 = −1.45075e−02, A6 = −2.99036e−03, A8 = −3.41593e−02,
A10 = 1.44787e−02
5th surface
K = −1.179
A4 = −5.64628e−02, A6 = −1.14086e−02, A8 = 7.32971e−03,
A10 = 6.13599e−03
6th surface
K = −0.868
A4 = −3.88681e−03, A6 = −9.37518e−03, A8 = 2.17085e−02,
A10 = 4.71438e−05
7th surface
K = −0.370
A4 = 1.08504e−03, A6 = −3.68400e−02, A8 = 1.45648e−02,
A10 = −4.26925e−03
8th surface
K = −3.625
A4 = −4.51723e−02, A6 = −1.74045e−03, A8 = −5.43564e−03,
A10 = 4.36897e−03
9th surface
K = 0.000
A4 = −6.85813e−02, A6 = −6.14488e−03, A8 = 6.88174e−03,
A10 = −7.19530e−04
10th surface
K = −7.752
A4 = −6.18305e−02, A6 = 1.36568e−02, A8 = −2.77902e−03,
A10 = 2.18756e−04, A12 = 1.00000e−06, A14 = −1.00000e−06

| | |
|---|---|
| Fno. | 2.0 |
| BF(in air) | 1.32 |
| Lens total length(in air) | 5.01 |
| Focal length | 4.19 |
| Image height | 2.9 |

### Example 4

Unit mm
Surface data

| Surface no. | r | d | nd | νd |
|---|---|---|---|---|
| Object plane | ∞ | ∞ | | |
| 1(Stop) | ∞ | −0.25 | | |
| 2* | 1.844 | 0.79 | 1.52400 | 50.40 |
| 3* | −2.678 | 0.18 | 1.61700 | 27.20 |
| 4* | −8.597 | 0.05 | | |
| 5* | 8.088 | 0.35 | 1.61420 | 25.60 |
| 6* | 2.456 | 0.73 | | |
| 7* | −4.844 | 0.85 | 1.53367 | 55.87 |
| 8* | −1.067 | 0.20 | | |
| 9* | −20.512 | 0.50 | 1.53367 | 55.87 |
| 10* | 1.236 | 0.60 | | |
| 11 | ∞ | 0.30 | 1.51633 | 64.14 |
| 12 | ∞ | 0.52 | | |
| Image plane | ∞ | | | |
| (Light receiving surface) | | | | |

Aspherical surface data

2nd surface
K = −0.101
A4 = −9.12516e−03, A6 = 1.11727e−02, A8 = −1.12394e−02,
A10 = −9.75791e−04
3rd surface
K = −3.000
A4 = 7.46085e−02, A6 = −4.75803e−02, A8 = −4.45225e−02,
A10 = 1.57733e−02
4th surface
K = 1.006
A4 = −1.40656e−02, A6 = 1.50753e−04, A8 = −3.27199e−02,
A10 = 1.32312e−02
5th surface
K = −1.586
A4 = −5.48934e−02, A6 = −1.44900e−02, A8 = 4.13210e−03,
A10 = 9.20419e−03
6th surface
K = −0.977
A4 = −4.75939e−03, A6 = −7.96963e−03, A8 = 2.68478e−04,
A10 = 1.41615e−02
7th surface
K = −4.748
A4 = 5.27600e−03, A6 = −3.41751e−02, A8 = 1.82030e−02,
A10 = −1.06920e−02
8th surface
K = −3.886
A4 = −4.35304e−02, A6 = 4.01251e−03, A8 = −2.08901e−03,
A10 = 2.21782e−03
9th surface
K = 0.000
A4 = −6.49350e−02, A6 = −6.89170e−03, A8 = 7.99149e−03,
A10 = −9.78412e−04
10th surface
K = −7.724
A4 = −6.34728e−02, A6 = 1.35743e−02, A8 = −2.85861e−03,
A10 = 2.30731e−04, A12 = 1.00000e−06, A14 = −1.00000e−06

| | |
|---|---|
| Fno. | 2.0 |
| BF(in air) | 1.32 |
| Lens total length(in air) | 4.97 |
| Focal length | 4.20 |
| Image height | 2.9 |

### Example 5

Unit mm
Surface data

| Surface no. | r | d | nd | νd |
|---|---|---|---|---|
| Object plane | ∞ | ∞ | | |
| 1(Stop) | ∞ | −0.25 | | |
| 2* | 1.735 | 0.73 | 1.52400 | 50.40 |
| 3* | −2.780 | 0.18 | 1.61700 | 27.20 |
| 4* | −14.608 | 0.05 | | |
| 5* | 6.165 | 0.35 | 1.61420 | 25.60 |
| 6* | 2.365 | 0.68 | | |
| 7* | −6.723 | 1.03 | 1.53367 | 55.87 |
| 8* | −0.986 | 0.14 | | |
| 9* | −5.018 | 0.50 | 1.53367 | 55.87 |
| 10* | 1.233 | 0.60 | | |
| 11 | ∞ | 0.30 | 1.51633 | 64.14 |
| 12 | ∞ | 0.49 | | |
| Image plane | ∞ | | | |
| (Light receiving surface) | | | | |

Aspherical surface data

2nd surface
K = −0.205
A4 = 4.83366e−03, A6 = −1.98339e−02, A8 = 2.93708e−02,
A10 = −2.12237e−02
3rd surface
K = −0.010
A4 = 1.55379e−01, A6 = −9.59881e−02, A8 = −1.58001e−01,
A10 = 1.02101e−01
4th surface
K = 0.513
A4 = −1.59186e−02, A6 = −4.85592e−02, A8 = −2.09509e−02,
A10 = 2.08039e−02
5th surface
K = −1.225
A4 = −7.81553e−02, A6 = −1.41668e−02, A8 = −2.33163e−02,
A10 = 3.12065e−02
6th surface
K = −0.454
A4 = −2.46822e−04, A6 = −1.22881e−02, A8 = 2.56899e−02,
A10 = 6.16740e−03
7th surface
K = 8.180
A4 = −1.20379e−02, A6 = −1.31761e−02, A8 = −5.55024e−03,
A10 = 2.57924e−03
8th surface
K = −3.871
A4 = −6.11054e−02, A6 = 6.65414e−03, A8 = −5.99584e−03,
A10 = 3.32831e−03
9th surface
K = 0.000
A4 = −5.95264e−02, A6 = −1.09569e−02, A8 = 8.05492e−03,
A10 = −6.80411e−04
10th surface
K = −9.260
A4 = −6.34240e−02, A6 = 1.48942e−02, A8 = −3.32180e−03,
A10 = 2.74039e−04, A12 = 1.00000e−06, A14 = −1.00000e−06

| | |
|---|---|
| Fno. | 2.0 |
| BF(in air) | 1.29 |
| Lens total length(in air) | 4.95 |
| Focal length | 4.20 |
| Image height | 2.9 |

Further, values of the conditional expressions are shown as below:

| Conditional expression | Example1 | Example2 | Example3 |
|---|---|---|---|
| (1) (r2 + r4)/(r2 − r4) | −0.56 | −0.56 | −0.62 |
| (2) f12/f | 0.90 | 0.69 | 0.93 |
| (3) d6/f | 0.18 | 0.18 | 0.16 |
| (4) f12/f4 | 1.48 | 1.15 | 1.71 |
| (5) \|f5/f\| | 0.59 | 0.59 | 0.50 |
| (6) d23/TL | 0.25 | 0.25 | 0.25 |

| Conditional expression | Example4 | Example5 |
|---|---|---|
| (1) (r2 + r4)/(r2 − r4) | −0.65 | −0.79 |
| (2) f12/f | 0.93 | 0.87 |
| (3) d6/f | 0.17 | 0.16 |
| (4) f12/f4 | 1.66 | 1.80 |
| (5) \|f5/f\| | 0.51 | 0.43 |
| (6) d23/TL | 0.27 | 0.25 |

Thus, it is possible to use such image taking optical system of the present invention in a photographic apparatus in which an image of an object is photographed by an electronic image pickup element such as a CCD and a CMOS, particularly a digital camera and a video camera, a personal computer, a telephone, and a portable terminal which are examples of an information processing unit, particularly a portable telephone which is easy to carry. Embodiments thereof will be exemplified below.

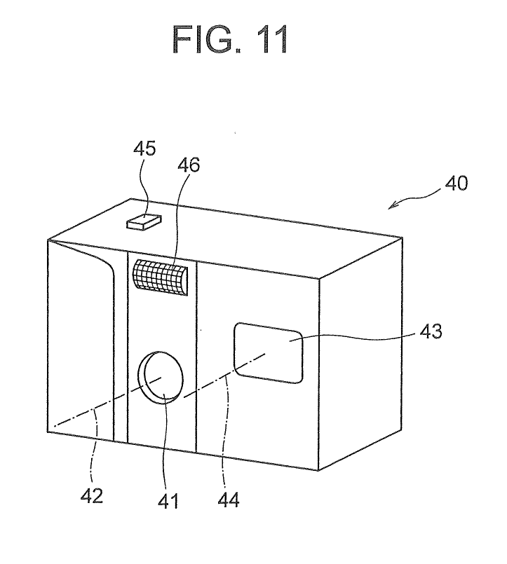

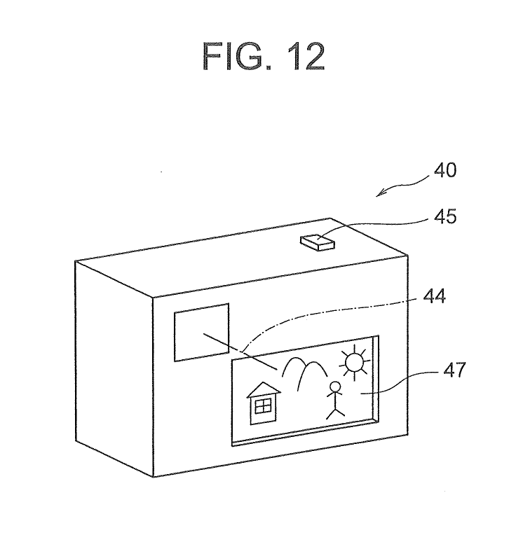

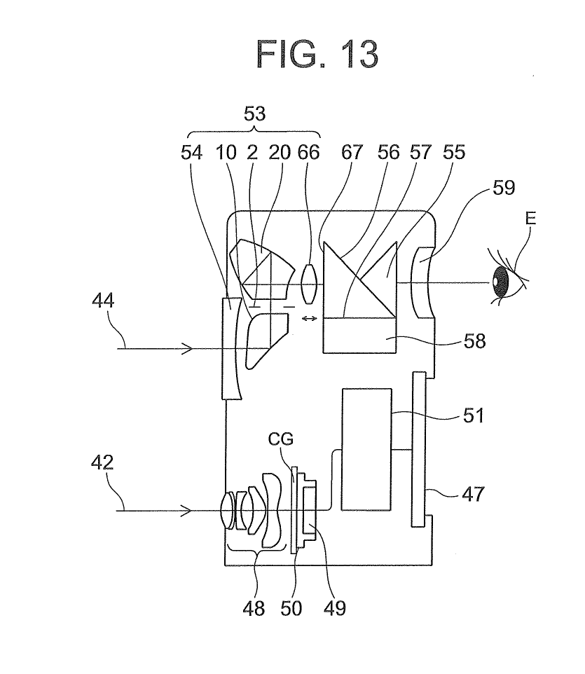

FIG. 11 to FIG. 13 show conceptual diagrams of structures in which the image taking optical system according to the present invention is incorporated in a photographic optical system 41 of a digital camera. FIG. 11 is a frontward perspective view showing an appearance of a digital camera 40, FIG. 12 is a rearward perspective view of the same, and FIG. 13 is a cross-sectional view showing an optical arrangement of the digital camera 40.

The digital camera 40, in a case of this example, includes the photographic optical system 41 having an optical path for photography 42, a finder optical system 43 having an optical path for finder 44, a shutter 45, a flash 46, and a liquid-crystal display monitor 47. Moreover, when the shutter 45 disposed at an upper portion of the camera 40 is pressed, in conjugation with this, a photograph is taken through the photographic optical system 41 such as the image taking optical system 48 in the first example.

An object image formed by the photographic optical system 41 is formed on an image pickup surface 50 of a CCD 49. The object image received at the CCD 49 is displayed on the liquid-crystal display monitor 47 which is provided on a camera rear surface as an electronic image, via an image processing means 51. Moreover, a memory etc. is disposed in the image processing means 51, and it is possible to record the electronic image photographed. This memory may be provided separately from the image processing means 51, or may be formed by carrying out by writing by recording (recorded writing) electronically by a floppy (registered trademark) disc, memory card, or an MO etc.

Furthermore, an objective optical system for finder 53 is disposed in the optical path for finder 44. This objective optical system for finder 53 includes a cover lens 54, a first prism 10, an aperture stop 2, a second prism 20, and a lens for focusing 66. An object image is formed on an image forming surface 67 by this objective optical system for finder 53. This object image is formed in a field frame of a Porro prism which is an image erecting member equipped with a first reflecting surface 56 and a second reflecting surface 58. On a rear side of this Porro prism, an eyepiece optical system 59 which guides an image formed as an erected normal image is disposed.

By the digital camera 40 structured in such manner, it is possible to realize an optical image pickup apparatus having an image taking optical system with a reduced size and thickness, in which the number of structural components of the photographic optical system 41 is reduced. Further, the present invention could be applied to the above-mentioned collapsible type digital camera as well as a bending type (an optical path reflecting type) digital camera having a bending optical system (optical path reflecting lens).

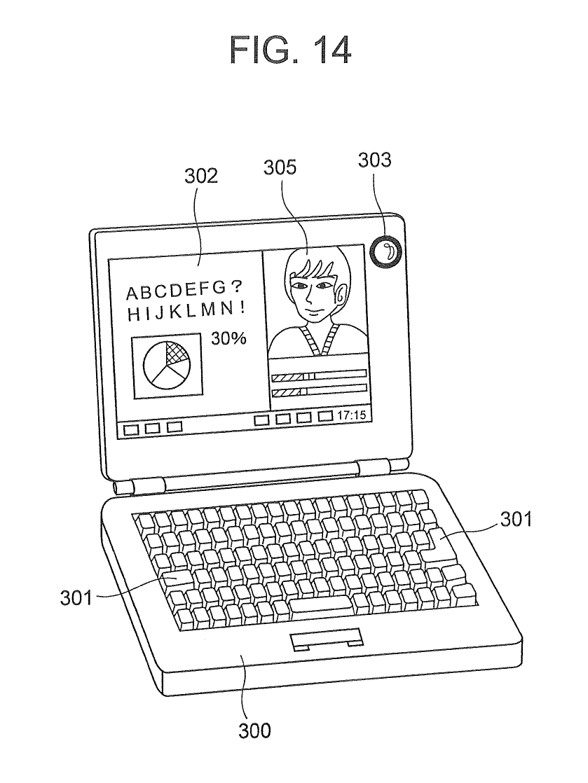

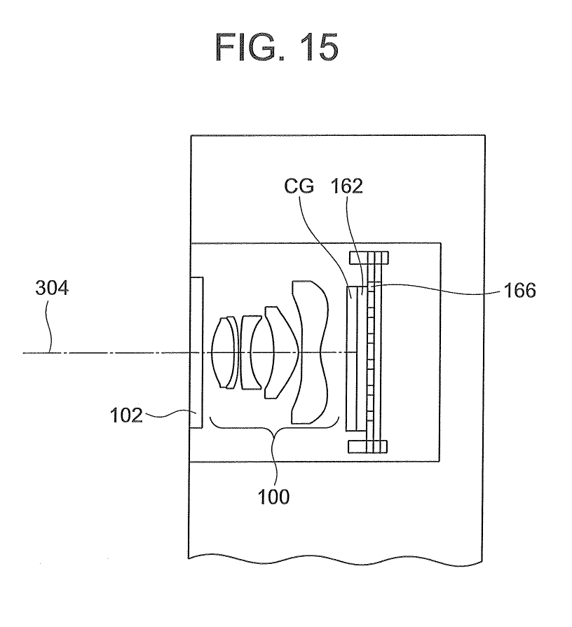

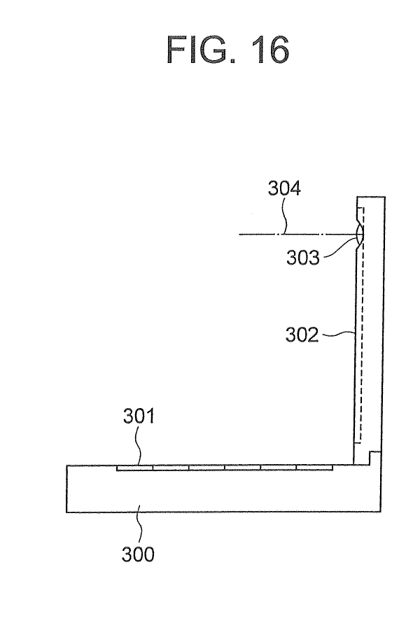

Next, a personal computer which is an example of an information processing apparatus with a built-in image taking optical system as an objective optical system is shown in FIG. 14 to FIG. 16. FIG. 14 is a frontward perspective view of a personal computer 300 with its cover opened, FIG. 15 is a cross-sectional view of a photographic optical system 303 of the personal computer 300, and FIG. 16 is a side view of FIG. 14. As it is shown in FIG. 14 to FIG. 16, the personal computer 300 has a keyboard 301, an information processing means and a recording means, a monitor 302, and a photographic optical system 303.

Here, the keyboard 301 is for an operator to input information from an outside. The information processing means and the recording means are omitted in the diagram. The monitor 302 is for displaying the information to the operator. The photographic optical system 303 is for photographing an image of the operator or a surrounding. The monitor 302 may be a display such as a liquid-crystal display or a CRT display. As the liquid-crystal display, a transmission liquid-crystal display device which illuminates from a rear surface by a backlight not shown in the diagram, and a reflection liquid-crystal display device which displays by reflecting light from a front surface are available. Moreover, in the diagram, the photographic optical system 303 is built-in at a right side of the monitor 302, but without restricting to this location, the photographic optical system 303 may be anywhere around the monitor 302 and the keyboard 301.

This photographic optical system 303 has an objective optical system 100 such as the image taking optical system in the first example for instance, and an electronic image pickup element chip 162 which receives an image, disposed along a photographic optical path 304. These are built into the personal computer 300.

At a front end of a mirror frame, a cover glass 102 for protecting the objective optical system 100 is disposed.

An object image received at the electronic image pickup element chip 162 is input to a processing means of the personal computer 300 via a terminal 166. Further, the object image is displayed as an electronic image on the monitor 302. In FIG. 14, an image 305 photographed by the user is displayed as an example of the electronic image. Moreover, it is also possible to display the image 305 on a personal computer of a communication counterpart from a remote location via a processing means. For transmitting the image to the remote location, the Internet and telephone are used.

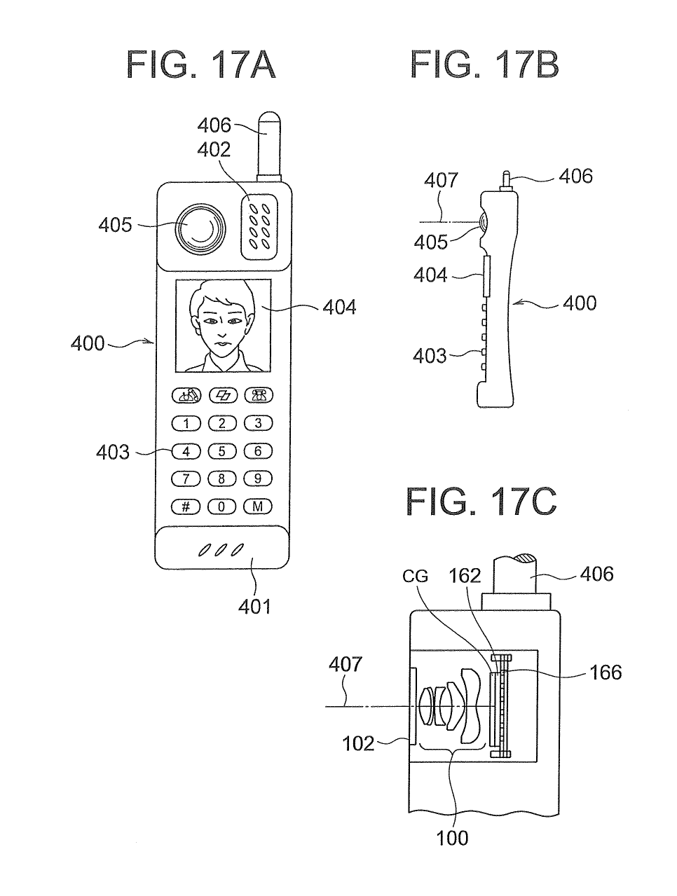

Next, a telephone which is an example of an information processing apparatus in which the image taking optical system of the present invention is built-in as a photographic optical system, particularly a portable telephone which is easy to carry is shown in FIG. 17A, FIG. 17B, and FIG. 17C. FIG. 17A is a front view of a portable telephone 400, FIG. 17B is a side view of the portable telephone 400, and FIG. 17C is a cross-sectional view of a photographic optical system 405. As shown in FIG. 17A to FIG. 17C, the portable telephone 400 includes a microphone section 401, a speaker section 402, an input dial 403, a monitor 404, the photographic optical system 405, an antenna 406, and a processing means.

Here, the microphone section 401 is for inputting a voice of the operator as information. The speaker section 402 is for outputting a voice of the communication counterpart. The input dial 403 is for the operator to input information. The monitor 404 is for displaying a photographic image of the operator himself and the communication counterpart, and information such as a telephone number. The antenna 406 is for carrying out a transmission and a reception of communication electric waves. The processing means (not shown in the diagram) is for carrying out processing of image information, communication information, and input signal etc.

Here, the monitor 404 is a liquid-crystal display device. Moreover, in the diagram, a position of disposing each structural element is not restricted in particular to a position in the diagram. This photographic optical system 405 has an objective optical system 100 which is disposed in a photographic optical path 407 and an image pickup element chip 162 which receives an object image. As the objective optical system 100, the zoom lens in the first example for instance, is used. These are built into the portable telephone 400.

At a front end of a mirror frame, a cover glass 102 for protecting the objective optical system 100 is disposed.

An object image received at the electronic image pickup element chip 162 is input to an image processing means which is not shown in the diagram, via a terminal 166. Further, the object image finally displayed as an electronic image on the monitor 404 or a monitor of the communication counterpart, or both. Moreover, a signal processing function is included in the processing means. In a case of transmitting an image to the communication counterpart, according to this function, information of the object image received at the electronic image pickup element chip 162 is converted to a signal which can be transmitted.

Various modifications can be made to the present invention without departing from its essence.

As described above, the present invention can suitably be applied to a high performance image taking optical system with well-corrected aberrations such as spherical aberration and coma that is relatively small in size while having a large diameter with an F-number of e.g. 2.0 or less.

The present invention can provide a bright (or fast) small-size image taking optical system with well-corrected aberrations (in particular, spherical aberration, coma, and axial chromatic aberration) and an image pickup apparatus equipped with such an image taking optical system.

What is claimed is:

1. An image taking optical system comprising, in order from the object side:
a first lens having a biconvex shape and having a positive refractive power;
a second lens having a meniscus shape with a concave surface facing the object side and having a negative refractive power;
a third lens having a negative refractive power;
a fourth lens having a meniscus shape with a concave surface facing the object side and having a positive refractive power; and
a fifth lens having a negative refractive power, wherein the first lens and the second lens are cemented together.

2. The image taking optical system according to claim 1, wherein the image taking optical system satisfies the following conditional expression (1):
−1.6<(r2+r4)/(r2−r4)<−0.2 (1),
where r2 is the paraxial radius of curvature of the object side surface of the first lens, and r4 is the paraxial radius of curvature of the image side surface of the second lens.

3. The image taking optical system according to claim 1, wherein the image taking optical system satisfies the following conditional expression (2):
0.3<f12/f<1.9 (2),
where f12 is the composite focal length of the first lens and the second lens, and f is the focal length of the entire image taking optical system.

4. The image taking optical system according to claim 1, wherein the image taking optical system satisfies the following conditional expression (3):
0.2<d6/f<1.2 (3),
where f is the focal length of the entire image taking optical system, and d6 is the air distance between the third lens and the fourth lens along the optical axis.

5. The image taking optical system according to claim 1, wherein the image taking optical system satisfies the following conditional expression (4):
0.5<f12/f4<3.6 (4),
where f12 is the composite focal length of the first lens and the second lens, and f4 is the focal length of the fourth lens.

6. The image taking optical system according to claim 1, wherein the fourth lens has a positive refractive power in its central portion and has a negative refractive power in its peripheral portion.

7. The image taking optical system according to claim 1, wherein the image taking optical system satisfies the following conditional expression (5):
0.21<|f5/f|<1.25 (5),
where f5 is the focal length of the fifth lens, and f is the focal length of the entire image taking optical system.

8. The image taking optical system according to claim 1, wherein the image taking optical system satisfies the following conditional expression (6):
0.1<d23/TL<0.5 (6),
where d23 is the thickness of the cemented lens, and TL is the distance from the vertex of the object side surface of the first lens to the vertex of the image side surface of the fifth lens.

9. The image taking optical system according to claim 1, wherein the negative refractive power of the second lens increases from the center toward the periphery thereof.

10. The image taking optical system according to claim 1, wherein the first lens, the second lens, the third lens, the fourth lens, and the fifth lens are each made of a resin.

11. An image pickup apparatus comprising:
an image taking optical system according to claim 1; and
an electronic image pickup element having an image pickup surface.

12. The image pickup apparatus according to claim 11 comprising an auto-focus mechanism integrated with the image taking optical system.

13. The image pickup apparatus according to claim 11, wherein the image taking optical system and the image pickup element are made integral.
